(19) United States
(12) Patent Application Publication
(10) Pub. No.: US 2015/0170609 A1
(43) Pub. Date: Jun. 18, 2015

(54) Driving Circuit for Display Apparatus

(71) Applicant: LG Display Co., Ltd., Seoul (KR)

(72) Inventor: Yong-Chae JUNG, Daegu (KR)

(21) Appl. No.: 14/298,676

(22) Filed: Jun. 6, 2014

(30) Foreign Application Priority Data
Dec. 13, 2013 (KR) 10-2013-0155665

(51) Int. Cl. G09G 5/18

(52) U.S. Cl. CPC G09G 5/18; G09G 2300/06

(57) ABSTRACT

A driving circuit for a display apparatus is disclosed. The driving circuit includes a frame rate determiner for determining a frame rate based on a reference timing signal provided from a system. The driving circuit also includes a gamma reference voltage generator for generating a plurality of gamma reference voltages. The driving circuit further includes a gamma voltage generator for receiving the plurality of gamma reference voltages from the gamma reference voltage generator to generate a plurality of gamma voltage groups, for selecting gamma voltages included in any one of the plurality of gamma voltage groups based on a determination result from the frame rate determiner, and for outputting the selected gamma voltages.

### CROSS-REFERENCE TO RELATED APPLICATION

This application claims the benefit of Korean Patent Application No. 10-2013-0155665, filed on Dec. 13, 2013, which is hereby incorporated by reference as if fully set forth herein.

### BACKGROUND

1. Technical Field

The present disclosure relates to a driving circuit for a display apparatus, and more particularly, to a driving circuit for a display apparatus for preventing flicker generated during conversion of a frame rate.

2. Discussion of the Related Art

In order to reduce power consumption, a display apparatus adjusts a frequency of a reference timing signal (e.g., a driving frequency) according to a frame rate. For example, when image data is input at a low frame rate corresponding to a still image, the display apparatus can reduce the driving frequency, thereby reducing power consumption.

However, a voltage holding time difference between pixels inevitably occurs during conversion of a frame rate. Thus, problems arise in terms of flicker whereby an image flickers during conversion of a frame rate. For example, when a still image is displayed at a low frame rate of 40 Hz, voltage holding time is longer than a case in which a still image is displayed at a high frame rate of 60 Hz. Thus, a holding voltage of a pixel during driving at a frame rate of 40 Hz is reduced compared with a holding voltage of a pixel during driving at a frame rate of 60 Hz. Due to this difference between holding voltages, flicker occurs.

### SUMMARY

Accordingly, embodiments of the present disclosure are directed to a driving circuit for a display apparatus that substantially obviates one or more problems due to limitations and disadvantages of the related art.

Embodiments of the disclosure provide a driving circuit for a display apparatus that prepares gamma voltage groups or gamma reference voltage groups with various levels per frame rate and provides a gamma voltage group or gamma reference voltage group required for a currently selected frame rate.

Additional advantages, objects, and features of the embodiments of this disclosure will be set forth in part in the description which follows and in part will become apparent to those having ordinary skill in the art upon examination of the following or may be learned from practice of these embodiments. The objectives and other advantages of the embodiments of this disclosure may be realized and attained by the structure particularly pointed out in the written description and claims hereof as well as the appended drawings.

To achieve these objects and other advantages and in accordance with the purpose of this disclosure, as embodied and broadly described herein, a driving circuit for a display apparatus includes a frame rate determiner for determining a frame rate based on a reference timing signal. The driving circuit also includes a gamma reference voltage generator for generating a plurality of gamma reference voltages. Additionally, the driving circuit includes a gamma voltage generator for receiving the plurality of gamma reference voltages from the gamma reference voltage generator to generate a plurality of gamma voltage groups, selecting gamma voltages included in any one of the plurality of gamma voltage groups based on a determination result from the frame rate determiner, and outputting the selected gamma voltages.

In some embodiments, the gamma voltage generator generates a plurality of predetermined gamma voltage groups based on a size of the determined frame rate. In such embodiments, and the gamma voltage generator selects a gamma voltage group with a lower voltage value as a size of the frame rate is increased.

The gamma voltage generator may include a plurality of gamma resistor strings for generating the plurality of gamma voltage groups, and a gamma string selector for selecting any one among the plurality of gamma resistor strings based on the determination result from the frame rate determiner, and outputting a gamma voltage group generated from the selected gamma resistor string.

At least one gamma voltage included in a gamma voltage group generated by any one of the gamma resistor strings and gamma voltages generated from the other gamma resistor strings, having a gray level corresponding to the gamma voltage, may have different voltage values.

Each gamma resistor string may include a plurality of gamma resistors for dividing the gamma reference voltages to generate a gamma voltage group, and at least one gamma resistor included in any one of the gamma resistor strings and gamma resistors connected to the other gamma resistor strings, corresponding to the gamma resistor, may have different resistance values.

Each gamma resistor string may include a plurality of gamma resistors for dividing the gamma reference voltages to generate a gamma voltage group, corresponding gamma resistors included in different gamma resistor strings may have the same value, and at least one gamma reference voltage applied to any one of the gamma resistor strings and gamma reference voltages applied to the other gamma resistor strings, corresponding to the gamma reference voltage, may have different values.

Gamma voltages with a highest gray level among gamma voltages generated from each gamma resistor string may have different values, or gamma voltages with a lowest gray level among gamma voltages generated from each gamma resistor string may have different values.

The driving circuit may further include a data driver for receiving a plurality of gamma voltages from the gamma voltage generator and converting image data into an analog signal using the gamma voltages, wherein the gamma voltage generator may be installed in the data driver.

In another aspect of the present disclosure, a driving circuit for a display apparatus includes a frame rate determiner for determining a frame rate based on a reference timing signal provided from a system, a gamma reference voltage generator containing gamma reference voltage groups prepared per size of the frame rate, for selecting and outputting any one of gamma reference voltage groups among the plural gamma reference voltage groups based on a determination result from the frame rate determiner, and a gamma voltage generator for generating a plurality of gamma voltages based on the gamma reference voltage group from the gamma reference voltage generator.

The gamma reference voltage generator may include a plurality of compensatory resistors having different resistance values, a resistor selector for selecting any one of the plural compensatory resistors based on the determination result from the frame rate determiner, a candidate voltage generator for dividing first and second reference voltages based on the compensatory resistor selected by the resistor selector to generate a plurality of candidate voltages, and a gamma reference voltage selector for selecting gamma reference voltages from the candidate voltages according to external selection control signals and outputting the selected gamma reference voltages as a gamma reference voltage group, and the reference resistors and the selected compensatory resistor may be connected in series between a first node to which the first reference voltage is applied and a second node to which the second reference voltage is applied.

The compensatory resistors may have predetermined resistance values per size of the frame rate, and the resistor selector may select a higher resistance value as the frame rate is increased.

The driving circuit may further include a selection signal generator for generating the selection control signals and providing the selection control signals to the gamma reference voltage selector, wherein the selection signal generator may control a logic state of the selection control signals based on the determination result from the frame rate determiner.

The driving circuit may further include a buffer for buffering a gamma reference voltage group from the gamma reference voltage generator and provides the gamma reference voltage group to the gamma voltage generator.

The driving circuit may further include a data driver for receiving a plurality of gamma voltages from the gamma voltage generator and converting image data into an analog signal using the gamma voltages, wherein at least one of the gamma reference voltage generator and the gamma voltage generator may be installed in the data driver.

The driving circuit may further include a timing controller for receiving image data provided from the system and outputting the image data according to timing, wherein the frame rate determiner may be installed in the timing controller.

It is to be understood that both the foregoing general description and the following detailed description of the present disclosure are exemplary and explanatory and are intended to provide further explanation of the embodiments of this disclosure, as claimed.

### BRIEF DESCRIPTION OF THE DRAWINGS

The accompanying drawings, which are included to provide a further understanding of the disclosure and are incorporated in and constitute a part of this application, illustrate embodiment(s) of the disclosure and together with the description serve to explain the principle of the disclosure. In the drawings:

FIG. 1 is a diagram illustrating a display apparatus including a driving circuit according to an embodiment of the disclosure;

FIG. 2 is a diagram illustrating a detailed structure of a gamma voltage generator of FIG. 1;

FIG. 3 is a diagram illustrating a detailed structure of a gamma string selector of FIG. 2;

FIG. 4 is a diagram illustrating a gamma reference voltage generator and a gamma voltage generator of FIG. 1 according to another embodiment;

FIG. 5 is a diagram for explanation of a selection signal generator controlled according to a frame signal, according to some embodiments; and

FIG. 6 is a table showing resistance values of resistors included in a gamma resistor string and a voltage difference between frame rates according to an embodiment.

### DETAILED DESCRIPTION

Reference will now be made in detail to the preferred embodiments of the present invention, examples of which are illustrated in the accompanying drawings. Wherever possible, the same reference numbers will be used throughout the drawings to refer to the same or like parts.

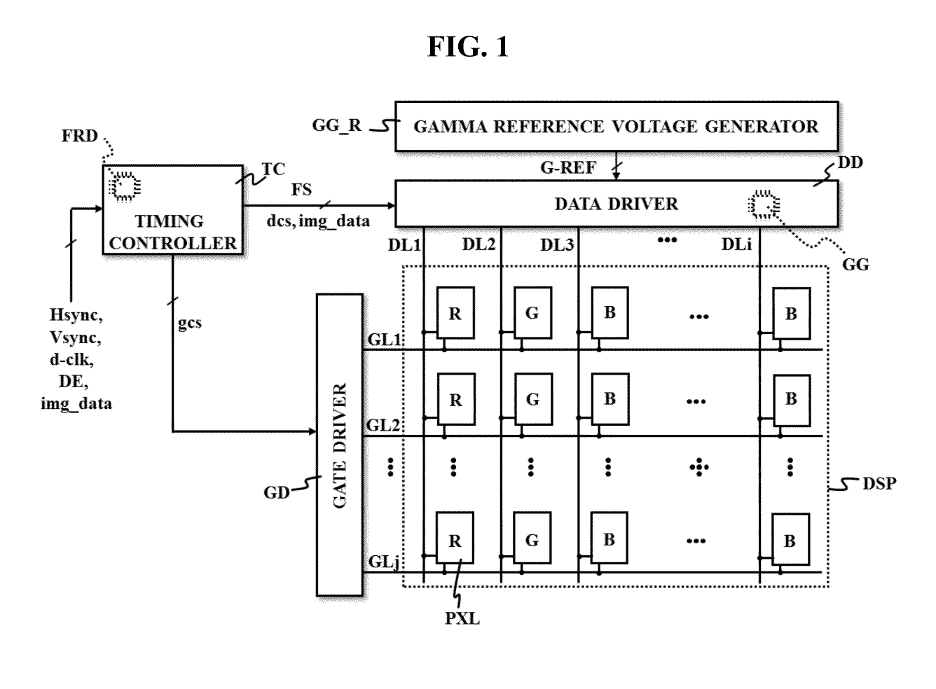

FIG. 1 is a diagram illustrating a display apparatus including a driving circuit according to an embodiment.

As illustrated in FIG. 1, the display apparatus according to the present embodiment includes a display DSP, a data driver DD, a gate driver GD, a timing controller TC, and a gamma reference voltage generator GG_R. Here, the data driver DD, the gate driver GD, the timing controller TC, and the gamma reference voltage generator GG_R constitute a driving circuit for a display apparatus for driving the display DSP so as to display an image on the display DSP. These listed components will be described in detail.

The display DSP includes a plurality of pixels PXLs, and i data lines DL1 to DLi and j gate lines GL1 to GLj for transmitting various signals required to display an image by the pixels PXLs, where i and j are each a natural number.

The pixels PXLs are arranged in a matrix form in the display DSP. The i pixels PXLs are arranged at each of horizontal lines. The pixels PXLs are classified into a red pixel R for displaying a red image, a green pixel G for displaying a green image, and a blue pixel B for displaying a blue image. In this case, three pixels, i.e., the red pixel R, the green pixel G, and the blue pixel B that are connected in the same gate line and adjacent to each other constitute one unit pixel. The unit pixel combines a red image, a green image, and a blue image to display one unit image.

The timing controller TC receives a horizontal synchronization signal Hsync, a vertical synchronization signal Vsync, a dot-clock signal d-clk, and image data img_data from a host system (not shown). In addition, the image data img_data is output to the data driver DD according to timing and also generates a data control signal dcs and a gate control signal gcs using the horizontal synchronization signal Hsync, the vertical synchronization signal Vsync, and the dot-clock signal d-clk. In addition, the timing controller TC determines a frame rate based on a reference timing signal provided from the host system. To this end, in some embodiments, the timing controller TC may include a frame rate determiner FRD. The frame rate determiner FRD receives reference timing signals such as the horizontal synchronization signal Hsync, the vertical synchronization signal Vsync, the dot-clock signal d-clk, a data enable signal DE, etc. and counts vertical synchronization signals to determine a frame rate. Here, the frame rate refers to a speed for displaying data of one image by the display apparatus, and has, for example, a size of 40 Hz, 60 Hz, 120 Hz, etc. In general, when an image to be displayed is a moving picture, the display apparatus is driven at a frame rate of 60 Hz or more, and when the image is a still image, the display apparatus is driven at a frame rate of 40 Hz. The frame rate determiner FRD determines a size of the determined frame rate. The frame rate determiner FRD outputs a frame signal FS with a predetermined value (e.g., a logic code) according to the size of the determined frame rate. According to a value of the frame signal FS, the timing controller TC determines a frame rate and modulates frequencies of the reference timing signals so as to have timing appropriate for the frame rate. When the frequencies of the reference timing signals are modulated, frequencies (i.e., driving frequencies) of the data control signal dcs and the gate control signal gcs, that are generated based on the modulated frequencies of the reference timing signals, are also modulated. That is, the timing controller TC may reduce the aforementioned driving frequency when data with a low frame rate like a still image is input to the timing controller TC, thereby reducing power consumption.

In some embodiments, the aforementioned frame rate determiner FRD is disposed outside the timing controller TC.

The frame signal FS generated from the frame rate determiner FRD is also supplied to the data driver DD. In this regard, a detail operation of the data driver DD according to the frame signal FS will be described below.

The data control signal dcs includes a source clock pulse signal, a source start pulse signal, a source output enable signal, and a polarity reversal control signal. The data control signal dcs is supplied by the timing controller TC to the data driver DD.

The gate control signal gcs includes a gate start pulse signal, a gate shift clock signal, and a gate output enable signal. The gate control signal gcs is supplied by the timing controller TC to the gate driver GD.

The gate driver GD generates gate signals according to the gate control signal gcs from the timing controller TC and sequentially supplies the gate signals to the plurality of gate lines GL1 to GLj to drive the gate lines GL1 to GLj.

The gamma reference voltage generator (GG_R) generates a plurality of gamma reference voltages G-REF and supplies the gamma reference voltages G-REF to the data driver DD. The gamma reference voltages G-REF are voltages required to generate gamma voltages by the data driver DD.

The data driver DD samples the image data img_data (image data from the timing controller TC) according to the data control signal dcs from the timing controller TC, latches the sampled image data img_data corresponding to one horizontal line every horizontal time 1H, 2H, . . . , and then, supplies the latched image data of one horizontal line to the data lines DL1 to DLi. In this case, the data driver DD generates a plurality of gamma voltages using the gamma reference voltages G-REF provided from the gamma reference voltage generator GG_R, converts the digital image data img_data into an analog signal using the gamma voltages, and supplies the analog signal to the data lines DL1 to DLi. To this end, the data driver DD may include a gamma voltage generator GG. The gamma voltage generator GG divides the gamma reference voltages G-REF from the gamma reference voltage generator GG_R to generate a plurality of gamma voltages. For example, the gamma reference voltage generator GG_R divides a reference voltage using internal resistors formed therein to generate the five gamma reference voltages G-REF with different voltages. In this regard, the five gamma reference voltages G-REF are input to the gamma voltage generator GG and are re-divided into 64 gamma voltages using a greater number of resistors. In some embodiments, the gamma voltage generator GG is located or installed outside and separate from the data driver DD.

In particular, the gamma voltage generator GG includes a plurality of predetermined gamma voltage groups per frame rate. In this regard, as the aforementioned determination result from the frame rate determiner FRD, the gamma voltage generator GG selects any one of the gamma voltage groups and provides the gamma voltages included in the gamma voltage group to the data driver DD. For example, when a frame rate has any one of 40 Hz, 60 Hz, and 120 Hz, the gamma voltage groups may also be configured by three groups. That is, the gamma voltage groups include a first gamma voltage group corresponding to a frame rate of 40 Hz, a second gamma voltage group corresponding to a frame rate of 60 Hz, and a third gamma voltage group corresponding to a frame rate of 120 Hz.

Each gamma voltage group includes gamma voltages with various gray level values having different voltage values. For example, one gamma voltage group may include gamma voltages with a gray level value 0 to 63. The respective gamma voltage groups include gamma voltages with the same gray level value. In this case, gamma voltages belonging to different gamma voltage groups and having the same gray level value may have different voltage values. For example, a gamma voltage of a first gray level included in a first gamma voltage group, a gamma voltage of first gray level included in a second gamma voltage group, and a gamma voltage of the first gray level included in a third gamma voltage group may have different voltage values. As another example, corresponding gamma voltages of all gray levels, included in the respective gamma voltage groups, may have different voltage values. For example, gamma voltages of all levels included in the first gamma voltage group, gamma voltages of all levels included in the second gamma voltage group, and gamma voltages of all levels included in the third gamma voltage group may have correspondingly different voltage values. In this case, voltage values of gamma voltages of all gray levels included in the first gamma voltage group may be set to be greater than voltage values of gamma voltages of all gray levels included in the second gamma voltage group. In addition, voltage values of gamma voltages of all gray levels included in the third gamma voltage group may be set to be smaller than voltage values of gamma voltages of all gray levels included in the second gamma voltage group. Accordingly, in this case, a gamma voltage of a specific gray level included in the second gamma voltage group has a smaller voltage value than a gamma voltage of a specific gray level included in the first gamma voltage group and has a greater voltage value than a gamma voltage of a specific gray level included in the third gamma voltage group. In this case, as a frame rate is increased, the gamma voltage generator GG selects a gamma voltage group having a smaller voltage value. For example, when a frame rate is 40 Hz, 64 gamma voltages included in the first gamma voltage group may be selected, when a frame rate is 60 Hz, 64 gamma voltages included in the second gamma voltage group may be selected, and when a frame rate is 120 Hz, 64 gamma voltages included in the third gamma voltage group may be selected.

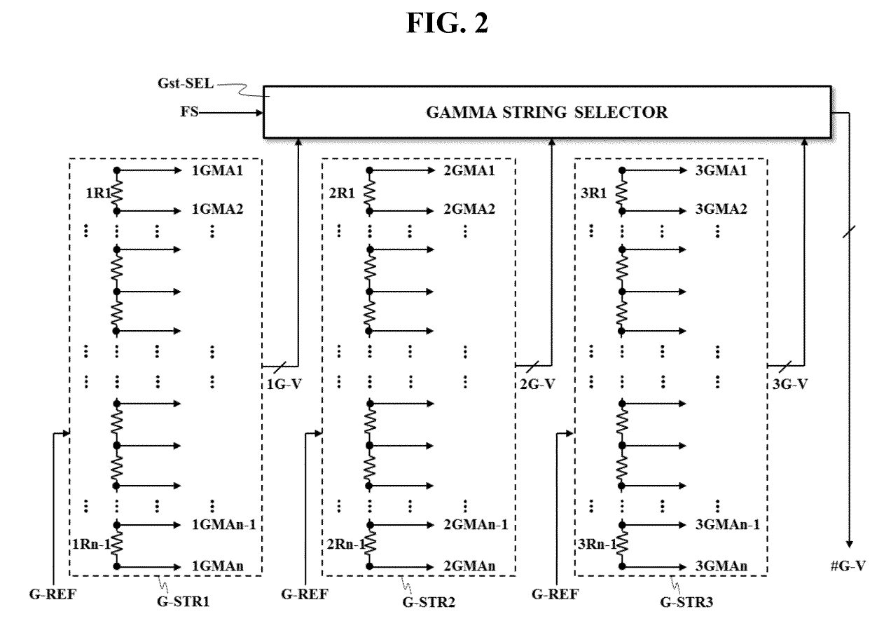

In order to perform the aforementioned functions, the gamma voltage generator GG according to some embodiments has a structure illustrated in FIG. 2. This is purely exemplary. Structural variations may be applied to these embodiments as long as these functions can be achieved.

FIG. 2 is a diagram illustrating a detailed structure of the gamma voltage generator GG of FIG. 1.

As illustrated in FIG. 2, the gamma voltage generator GG includes first to third gamma resistor strings G-STR1 to G-STR3 and a gamma string selector Gst-SEL.

The first to third gamma resistor strings G-STR1 to G-STR3 divide the gamma reference voltages G-REF applied thereto using internal resistors to generate a plurality of gamma voltage groups 1G-V to 3G-V, respectively. To this end, the first to third gamma resistor strings G-STR1 to G-STR3 include a plurality of gamma resistors 1R1 to 1Rn-1, 2R1 to 2Rn-1, and 3R1 to 3Rn-1. For example, the first gamma resistor string G-STR1 includes a plurality of first to (n−1)ₜₕ gamma resistors 1R1 to 1Rn-1 that are connected in series, the second gamma resistor string G-STR2 includes a plurality of first to (n−1)ₜₕ gamma resistors 2R1 to 2Rn-1 that are connected in series, and the third gamma resistor string G-STR3 includes a plurality of first to (n−1)ₜₕ gamma resistors 3R1 to 3Rn-1 that are connected in series.

Here, the first gamma resistor string G-STR1 receives a plurality of gamma reference voltages GREFs and divides the gamma reference voltages GREFs using gamma resistors 1R1 to 1Rn-1 formed in the first gamma resistor string G-STR1 to generate first to nₜₕ gamma voltages 1GMA1 to 1GMAn. The first to nₜₕ gamma voltages 1GMA1 to 1GMAn belong to the aforementioned first gamma voltage group 1G-V. The second gamma resistor string G-STR2 receives the plurality of gamma reference voltages G-REFs and divides the gamma reference voltages G-REFs using gamma resistors 2R1 to 2Rn-1 formed in the second gamma resistor string G-STR2 to generate first to nth gamma voltages 2GMA1 to 2GMAn. The first to nth gamma voltages 2GMA1 to 2GMAn belong to the aforementioned second gamma voltage group 2G-V. The third gamma resistor string G-STR3 receives the plural gamma reference voltages G-REFs and divides the gamma reference voltages G-REFs using gamma resistors 3R1 to 3Rn-1 formed in the third gamma resistor string G-STR3 to generate first to nth gamma voltages 3GMA1 to 3GMAn. The first to nth gamma voltages 3GMA1 to 3GMAn belong to the aforementioned third gamma voltage group 3G-V.

Here, in order to vary values of the gamma voltage groups 1G-V to 3G-V, at least one gamma resistor included in any one of gamma resistor strings and gamma resistors corresponding to the gamma resistor and connected to other gamma resistor strings may have different resistance values. In this case, gamma voltages with a highest gray level among gamma voltages generated from each gamma resistor string may have different voltage values, or gamma voltages with a lowest gray level among gamma voltages generated from each gamma resistor string may have different voltage values. For example, a (n−1)ₜₕ gamma resistor gamma resistor 1Rn-1 included in the first gamma resistor string G-STR1, a (n−1)ₜₕ gamma resistor gamma resistor 2Rn-1 included in the second gamma resistor string G-STR2 corresponding to the (n−1)ₜₕ gamma resistor gamma resistor 1Rn-1 included in the first gamma resistor string G-STR1, and a (n−1)ₜₕ gamma resistor gamma resistor 3Rn-1 included in the third gamma resistor string G-STR3 corresponding to the (n−1)ₜₕ gamma resistor gamma resistor 1Rn-1 included in the first gamma resistor string G-STR1 may have different resistor values. In addition, all corresponding different gamma resistors may also have different resistor value like the aforementioned (n−1)ₜₕ gamma resistors.

According to another embodiment, corresponding gamma resistors included in different gamma resistor strings may be configured to have the same value, and at least one gamma reference voltage applied to any one of the gamma resistor strings and gamma reference voltages applied to different gamma resistor strings corresponding to the gamma reference voltage may be configured to have different values so as to vary the values of the gamma voltage groups 1G-V to 3G-V. For example, when the gamma reference voltages G-REF include five gamma reference voltages (first to fifth gamma reference voltages) having different voltage values, at least one of the five gamma reference voltages applied to a first gamma resistor string GSTR1, at least one of the five gamma reference voltages applied to a second gamma resistor sting G-STR2, and at least one of the five gamma reference voltages applied to the third gamma resistor string G-STR3 may have different voltage values.

The gamma string selector Gst-SEL selects any one of the first to third gamma resistor strings G-STR1 to G-STR3 based on the determination result from the frame rate determiner FRD and outputs a gamma voltage group generated from the selected gamma resistor string. To this end, the gamma string selector Gst-SEL receives the frame signal FS generated from the frame rate determiner FRD. In FIG. 2, the reference numeral ‘#’ of the reference numeral ‘#G-V’ refers to a natural number. As illustrated in FIG. 2, when three gamma resistor strings are configured, # is any one among 1 to 3.

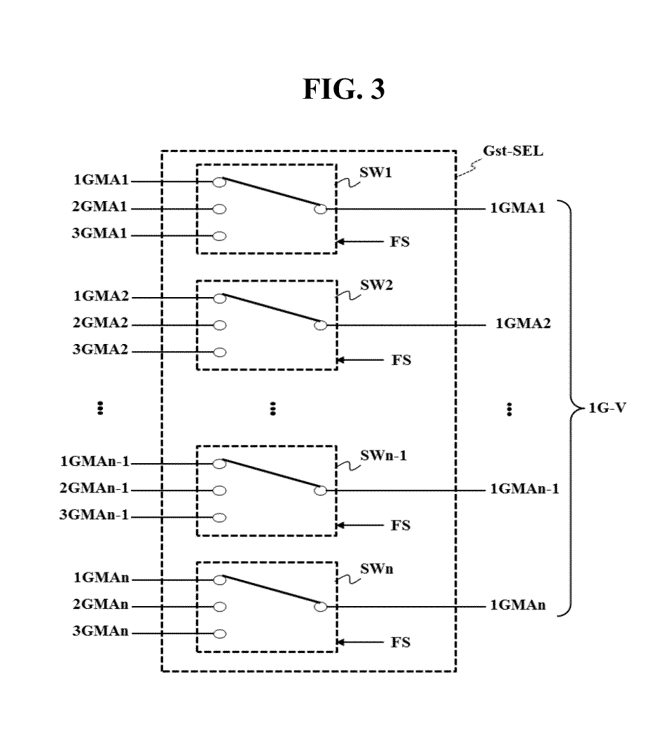

In order to perform the aforementioned function, the gamma string selector Gst-SEL according to the present invention has a structure illustrated in FIG. 3. This is purely exemplary. Any structure may be applied to the present invention as long as the function can be achieved.

FIG. 3 is a diagram illustrating a detailed structure of the gamma string selector Gst-SEL of FIG. 2.

As illustrated in FIG. 3, the gamma string selector Gst-SEL includes first to nth switches SW1 to SWn corresponding to the number of gamma voltages per gamma voltage group. The first to nth switches SW1 to SWn may include a triode switch including selection terminals, the number of which corresponds to the number of gamma resistor strings, for example, three selection terminals. All the switches SW1 to SWn commonly receive the frame signal FS and selects and outputs any one (e.g., a common or corresponding one) of three gamma voltages supplied to the switches SW1 to SWn according to a logic code of the frame signal FS. In this case, all the switches SW1 to SWn are commonly controlled by one frame signal FS and thus select gamma voltages provided by a common one of the gamma resistor strings in response to the frame signal FS. For example, when the frame signal FS contains information about a frame rate of 40 Hz, all the switches SW1 to SWn select and output only n gamma voltages 1GMA1 to 1GMAn provided from the common first gamma resistor string G-STR1 corresponding to the common first gamma voltage group 1G-V. Stated differently, in the example of FIG. 3, responsive to the determined frame rate being 40 Hz, frame signal FS causes switch SW1 to select the first gamma resistor string and output the corresponding gamma voltage 1GMA1, switch SW2 to also select the first gamma resistor string and output the corresponding gamma voltage 1GMA2, and so on.

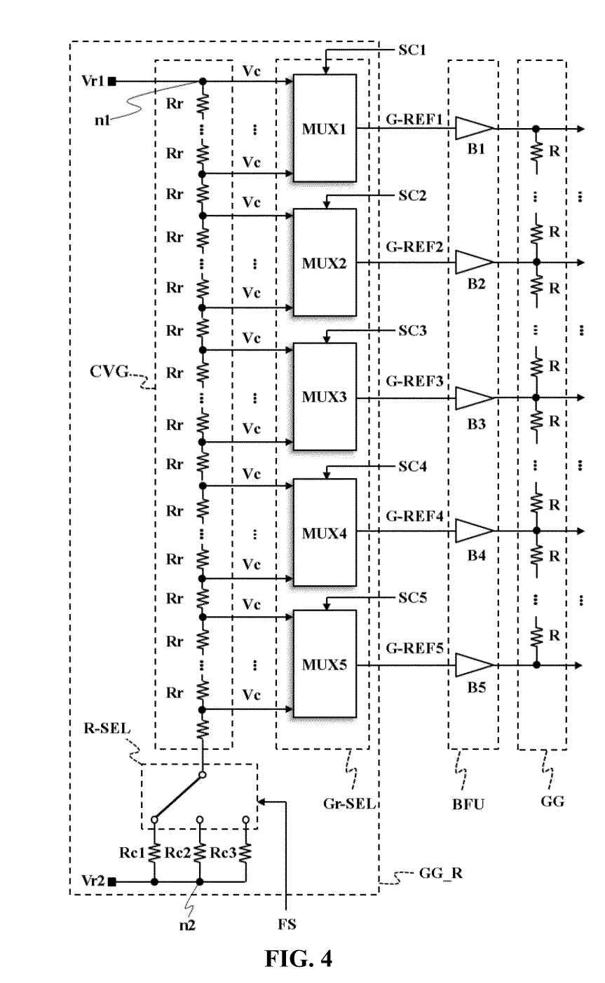

The gamma reference voltage generator GG_R and the gamma voltage generator GG according to the present invention may have a structure illustrated in FIG. 4.

FIG. 4 is a diagram illustrating the gamma reference voltage generator GG_R and the gamma voltage generator GG of FIG. 1 according to another embodiment.

The gamma voltage generator GG proposed in FIG. 4 includes a plurality of predetermined gamma reference voltage groups according to a corresponding plurality of frame rate sizes. In this regard, any one of gamma reference voltage groups is selected according to the aforementioned determination result from the frame rate determiner FRD and the gamma reference voltages G-REF1 to G-REF5 included in the selected gamma reference voltage group are applied to the gamma voltage generator GG through a buffer BFU. For example, when a frame rate has any one of 40 Hz, 60 Hz, and 120 Hz, three gamma reference voltage groups may be configured. That is, the three gamma reference voltage groups may include a first gamma reference voltage group corresponding to a frame rate of 40 Hz, a second gamma reference voltage group corresponding to a frame rate of 60 Hz, and a third gamma reference voltage group corresponding to a frame rate of 120 Hz.

Each gamma reference voltage group includes a plurality of gamma reference voltages with different voltage values. For example, one gamma reference voltage group may include five gamma reference voltages with different voltage values. The gamma reference voltage groups include the same number of gamma reference voltages. In this case, gamma reference voltages belonging to different gamma reference voltage groups and corresponding to each other may have different voltage values. For example, when each of the first to third gamma reference voltage groups include first to fifth gamma reference voltages G-REF1 to G-REF5, the first gamma voltage G-REF1 included in the first gamma reference voltage group, the first gamma reference voltage G-REF1 included in the second gamma reference voltage group, and the first gamma reference voltage G-REF1 included in the third gamma reference voltage group may have different voltage values. As another example, all gamma reference voltages belonging to the gamma reference voltage groups and corresponding to each other may have different voltage values. For example, gamma reference voltages with all levels included in the first gamma reference voltage group, gamma reference voltages with all levels included in the second gamma reference voltage group, and gamma reference voltages with all levels included in the third gamma reference voltage group may have correspondingly different voltage values. In this case, voltage values of all the gamma reference voltages G-REF1 to G-REF5 included in the first gamma reference voltage group may be set to be greater than voltage values of all the gamma reference voltages G-REF1 to G-REF5 included in the second gamma reference voltage group. In addition, voltage values of all the gamma reference voltages G-REF1 to G-REF5 included in the third gamma reference voltage group may be set to be smaller than voltage values of all the gamma reference voltages included in the second gamma reference voltage group. Accordingly, in this case, a specific gamma reference voltage included in the second gamma reference voltage group has a smaller voltage value than a gamma reference voltage included in the first gamma reference voltage group, corresponding to the specific gamma reference voltage and has a greater voltage value than a gamma reference voltage included in the third gamma reference voltage group, corresponding to the specific gamma reference voltage. In this case, as a frame rate is increased, the gamma reference voltage generator GG_R selects a gamma reference voltage group having a smaller voltage value. For example, when a frame rate is 40 Hz, five gamma reference voltages included in the first gamma reference voltage group are selected, when a frame rate is 60 Hz, five gamma reference voltages included in the second gamma reference voltage group are selected, and when a frame rate is 120 Hz, five gamma reference voltages included in the third gamma reference voltage group may be selected.

In order to perform the aforementioned functions, the gamma voltage generator GG according to the present embodiment has a structure illustrated in FIG. 4. This is purely exemplary. Alternative structures may be applied to the present embodiment as long as the stated functions can be achieved.

That is, as illustrated in FIG. 4, the gamma voltage generator GG includes a plurality of compensatory resistors Rc1 to Rc3, a resistor selector R-SEL, a candidate voltage generator CVG, and a gamma reference voltage selector Gr-SEL.

The compensatory resistors Rc1 to Rc3 have different resistance values. The number of the compensatory resistors Rc1 to Rc3 may be determined based on a number of possible values or sizes of the determined frame rate. For example, when a frame rate takes one of three values 40 Hz, 60 Hz, or 120 Hz, three compensatory resistors Rc1 to Rc3 may be configured. That is, the three compensatory resistors Rc1 to Rc3 may include the first compensatory resistor Rc1 corresponding to a frame rate of 40 Hz, the second compensatory resistor Rc2 corresponding to a frame rate of 60 Hz, and the third compensatory resistor Rc3 corresponding to a frame rate of 120 Hz. In this case, among these, the first compensatory resistor Rc1 has a highest resistance value, the third compensatory resistor Rc3 has a lowest resistance value, and the second compensatory resistor Rc2 has an intermediate resistance value between the first compensatory resistor Rc1 and the third compensatory resistor Rc3. One terminal of each of the compensatory resistors Rc1 to Rc3 is commonly connected to a second node n2, and a second reference voltage Vr2 is applied to the second node n2.

The resistor selector R-SEL selects any one of the plurality of compensatory resistors Rc1 to Rc3 based on the determination result (i.e., FS) from the frame rate determiner FRD. The resistor selector R-SEL may include a triode switch (e.g., a single pole triple throw switch) including selection terminals, the number of which corresponds to the number of gamma reference voltage groups to be generated, for example, three selection terminals. The resistor selector R-SEL selects any one of compensatory resistors according to a logic code of the frame signal FS. For example, when the frame signal FS contains information about a frame rate of 40 Hz, the resistor selector R-SEL may select the first compensatory resistor Rc1; when the frame signal FS contains information about a frame rate of 60 Hz, the resistor selector R-SEL may select the second compensatory resistor Rc2; and when the frame signal FS contains information about a frame rate of 120 Hz, the resistor selector R-SEL may select the third compensatory resistor Rc3.

The candidate voltage generator CVG includes a plurality of reference resistors Rr that are connected in series between a first node n1 and the resistor selector R-SEL. A first reference voltage Vr1 is applied to the first node n1. The first reference voltage Vr1 may have a greater value than a second reference voltage Vr2. The candidate voltage generator CVG divides the first and second reference voltages Vr1 and Vr2 using one internal reference resistors and compensatory resistor selected by the resistor selector R-SEL to generate a plurality of candidate voltages Vc. Some of the candidate voltages Vc function as the gamma reference voltages G-REF1 to G-REF5.

The gamma reference voltage selector Gr-SEL selects some of candidate voltages as gamma reference voltages according to external selection control signals SC1 to SC5 and outputs the selected gamma reference voltages as a gamma reference voltage group. To this end, the gamma reference voltage selector Gr-SEL includes a plurality of multiplexers MUX1 to MUX5. The first to fifth multiplexers MUX1 to MUX5 each selects any one of a plurality of candidate voltages applied thereto according to a logic code of the first to fifth selection control signals SC1 to SC5, and outputs the selected candidate voltage as one corresponding gamma reference voltage. First through fifth gamma reference voltages G-REF1 to G-REF5 output from the first to fifth multiplexers MUX1 to MUX5 constitute one gamma reference voltage group.

A buffer BFU illustrated in FIG. 4 includes a plurality of buffers B1 to B5. The first to fifth buffers B1 to B5 buffer signals of gamma reference voltages (G-REF1 to GREF-5) selected from the gamma reference voltage selector Gr-SEL and provide the buffered signals to the gamma voltage generator GG.

The gamma voltage generator GG illustrated in FIG. 4 includes a plurality of gamma resistors R that are connected in series. The gamma resistors R divide the gamma reference voltages G-REF1 to GREF-5 to generate a plurality of gamma voltages.

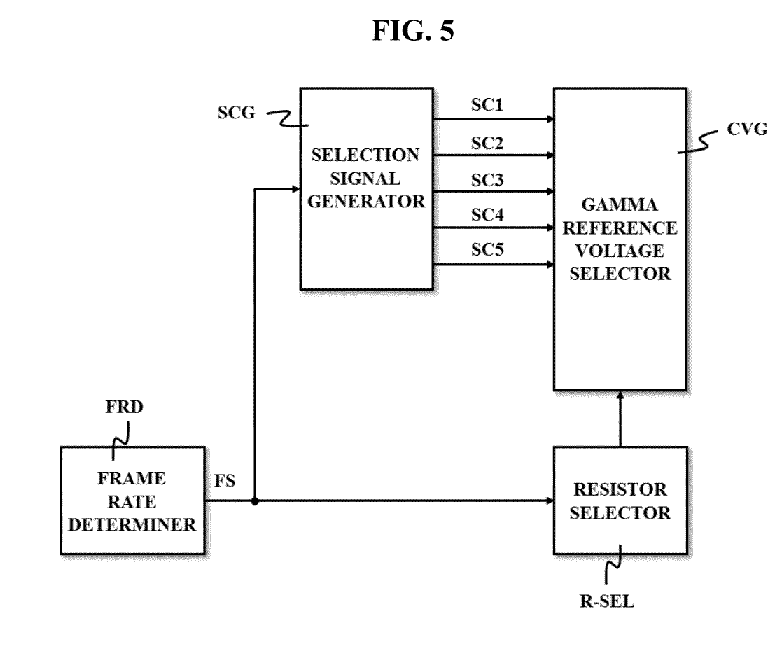

A logic code of the selection control signals SC1 to SC5 is controlled according to the frame signal FS, which will be described with reference to FIG. 5.

FIG. 5 is a diagram for explanation of a selection signal generator SCG controlled according to a frame signal.

As illustrated in FIG. 5, a driving circuit according to some embodiments includes the selection signal generator SCG for generating the selection control signals SC1 to SC5 and transmitting the selection control signals SC1 to SC5 to a gamma reference voltage selector CVG.

The selection signal generator SCG generates the selection control signals SC1 to SC5 having different logic codes according to the determination result from the frame rate determiner FRD. Accordingly, a compensatory resistor and a candidate voltage Vc may be selected together according to a logic code of the frame signal FS provided from the frame rate determiner FRD. In this case, although three compensatory resistors are present, a greater number of gamma reference voltage groups than three may be generated by combinations of candidate voltages to be selected. For example, when a frame rate is divided into four types and four logic codes of the frame signal FS are correspondingly configured, if a frame signal FS with a logic code of 00 is generated, the first compensatory resistor Rc1 may be selected, a first candidate voltage may be selected among eight candidate voltages input to the first multiplexer MUX1, and specific candidate voltages may be selected from the remaining multiplexers MUX2 to MUX5; if a frame signal FS with a logic code of 01 is generated, the second compensatory resistor Rc2 may be selected, a second candidate voltage may be selected among eight candidate voltages input to the first multiplexer MUX1, and specific candidate voltages may be selected from the remaining multiplexers MUX2 to MUX5; if a frame signal FS with a logic code of 10 is generated, the third compensatory resistor Rc3 may be selected, a third candidate voltage may be selected among eight candidate voltages input to the first multiplexer MUX1, and specific candidate voltages may be selected from the remaining multiplexers MUX2 to MUX5; and if a frame signal FS with a logic code of 11 is generated, the third compensatory resistor Rc3 may be selected, a fourth candidate voltage may be selected among eight candidate voltages input to the first multiplexer MUX1, and specific candidate voltages may be selected from the remaining multiplexers MUX2 to MUX5.

The driving circuit according to the present embodiments may prepare gamma voltage groups or gamma reference voltage groups with various levels per frame rate and provide a gamma voltage group or gamma reference voltage group required for a currently selected frame rate, thereby preventing flicker that may occur while a frame rate is changed. For example, high gamma voltages (or high gamma reference voltages) may be selected at a low frame rate, whereas low gamma voltages (low gamma reference voltages) may be selected a high frame rate, thereby reducing holding voltage difference between pixels.

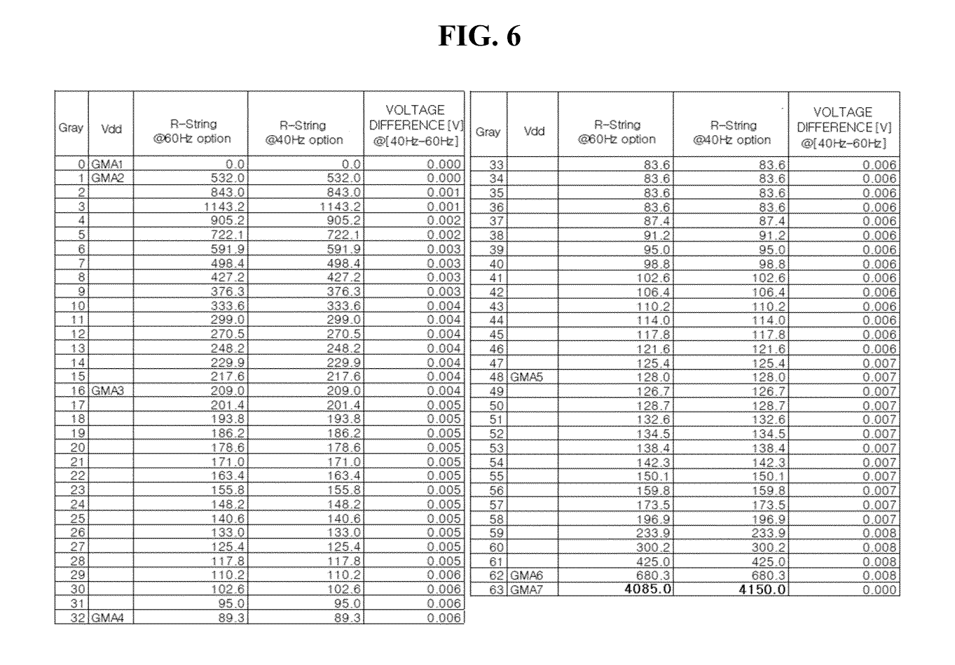

FIG. 6 is a table showing resistance values of resistors included in a gamma resistor string and a voltage difference between frame rates according to some embodiments.

FIG. 6 shows resistance values for generation of gamma voltages with a gray level value 0 to 63. For example, when a display apparatus is driven at a frame rate of 60 Hz, a resistor with 4085.0 [Ω] is used to generate a 63 gray level voltage GMA7, whereas when the display apparatus is driven at a frame rate of 40 Hz, a resistor with 4150.0 [Ω] is used to generate the same voltage, that is, 63 gray level voltage GMA7. In this case, resistance values corresponding to the other different gray levels are the same irrespective frame rates thereof. However, when only a resistor corresponding to a highest gray level (a 63 gray level) has a different value, gamma voltages at a frame rate of 40 Hz and gamma voltages with a frame rate of 60 Hz may be different. For example, in a 33 gray level, a gamma voltage generated at a frame rate of 40 Hz and a gamma voltage generated at a frame rate of 60 Hz are different by as much as 0.006 [V]. This means that the gamma voltage generated at a frame rate of 40 Hz is greater than the gamma voltage generated at a frame rate of 60 Hz by as much as 0.006 [V].

The driving circuit for a display apparatus according to the present disclosure has the following effects.

According to the present disclosure, the driving circuit may prepare gamma voltage groups or gamma reference voltage groups with various levels per frame rate and provide a gamma voltage group or gamma reference voltage group required for a currently selected frame rate. That is, as the currently selected frame rate is increased, the driving circuit for the display apparatus may select a lower gamma voltage group or gamma reference voltage, whereas as the frame rate is reduced, the driving circuit may select a higher gamma voltage group or gamma reference voltages, thereby preventing flicker that may occur while a frame rate is changed.

It will be apparent to those skilled in the art that various modifications and variations can be made in the present disclosure without departing from the spirit or scope of the disclosure. Thus, it is intended that the present disclosure covers the modifications and variations of this disclosure provided they come within the scope of the appended claims and their equivalents.

What is claimed is:

1. A driving circuit for a display apparatus, the driving circuit comprising:
a frame rate determiner for determining a frame rate based on a reference timing signal;
a gamma reference voltage generator for generating a plurality of gamma reference voltages; and
a gamma voltage generator for receiving the plurality of gamma reference voltages from the gamma reference voltage generator to generate a plurality of gamma voltage groups, selecting gamma voltages included in any one of the plurality of gamma voltage groups based on a determination result from the frame rate determiner, and outputting the selected gamma voltages.

2. The driving circuit according to claim 1, wherein:
the gamma voltage generator generates a plurality of predetermined gamma voltage groups based on a size of the determined frame rate; and
the gamma voltage generator selects a gamma voltage group of the generated plurality of gamma voltage groups, the selected gamma voltage group having a lower voltage value as a size of the determined frame rate is increased.

3. The driving circuit according to claim 1, wherein the gamma voltage generator comprises:
a plurality of gamma resistor strings for generating the plurality of gamma voltage groups; and
a gamma string selector for selecting any one among the plurality of gamma resistor strings based on the determination result from the frame rate determiner, and outputting a gamma voltage group generated from the selected gamma resistor string.

4. The driving circuit according to claim 3, wherein at least one gamma voltage included in a gamma voltage group generated by any one of the gamma resistor strings has a different voltage value than gamma voltages generated from other gamma resistor strings, having a gray level corresponding to the gamma voltage.

5. The driving circuit according to claim 4, wherein:
each gamma resistor string comprises a plurality of gamma resistors for dividing the plurality of gamma reference voltages to generate a gamma voltage group; and
at least one gamma resistor included in any one of the gamma resistor strings and gamma resistors connected to other gamma resistor strings, corresponding to the gamma resistor, have different resistance values.

6. The driving circuit according to claim 4, wherein each gamma resistor string comprises a plurality of gamma resistors for dividing the plurality of gamma reference voltages to generate a gamma voltage group;
corresponding gamma resistors included in different gamma resistor strings have equal resistance values; and
at least one gamma reference voltage applied to any one of the gamma resistor strings and gamma reference voltages applied to other gamma resistor strings, corresponding to the gamma reference voltage, have different voltage values.

7. The driving circuit according to claim 4, wherein:
gamma voltages corresponding to highest gray levels for each of the gamma resistor strings, have different voltage values; or
gamma voltages corresponding to lowest gray levels for each of the gamma resistor strings, have different voltage values.

8. The driving circuit according to claim 1, further comprising a data driver for receiving the selected gamma voltages from the gamma voltage generator and converting image data into an analog signal using the received gamma voltages,
wherein the gamma voltage generator is installed in the data driver.

9. The driving circuit according to claim 1, further comprising a timing controller for receiving image data provided from the system and outputting the image data,
wherein the frame rate determiner is installed in the timing controller.

10. A driving circuit for a display apparatus, the driving circuit comprising:
a frame rate determiner for determining a frame rate based on a reference timing signal provided from a system;
a gamma reference voltage generator containing gamma reference voltage groups prepared based on a size of the determined frame rate, for selecting and outputting any one of the plurality of gamma reference voltage groups based on a determination result from the frame rate determiner; and
a gamma voltage generator for generating a plurality of gamma voltages based on the selected gamma reference voltage group from the gamma reference voltage generator.

11. The driving circuit according to claim 10, wherein the gamma reference voltage generator comprises:
a plurality of compensatory resistors having different resistance values;
a resistor selector for selecting any one of the plurality of compensatory resistors based on the determination result from the frame rate determiner;
a candidate voltage generator for dividing first and second reference voltages based on the compensatory resistor selected by the resistor selector to generate a plurality of candidate voltages; and
a gamma reference voltage selector for selecting gamma reference voltages from the generated candidate voltages according to external selection control signals and outputting the selected gamma reference voltages as the selected gamma reference voltage group, and
wherein a plurality of reference resistors and the selected compensatory resistor are connected in series between a first node to which the first reference voltage is applied and a second node to which the second reference voltage is applied.

12. The driving circuit according to claim 11, wherein:
the compensatory resistors have predetermined resistance values based on frame rate sizes; and
the resistor selector selects a higher resistance value for a greater size of the determined frame rate.

13. The driving circuit according to claim 12, further comprising a selection signal generator for generating the selection control signals and providing the selection control signals to the gamma reference voltage selector,
wherein the selection signal generator controls a logic state of the selection control signals based on the determination result from the frame rate determiner.

14. The driving circuit according to claim 10, further comprising a buffer for buffering a gamma reference voltage group from the gamma reference voltage generator and providing the gamma reference voltage group to the gamma voltage generator.

15. The driving circuit according to claim 10, further comprising a data driver for receiving the plurality of gamma voltages from the gamma voltage generator and converting image data into an analog signal using the received gamma voltages,
wherein at least one of the gamma reference voltage generator and the gamma voltage generator is installed in the data driver.

16. The driving circuit according to claim 10, further comprising a timing controller for receiving image data provided from the system and outputting the image data,
wherein the frame rate determiner is installed in the timing controller.
